(19) United States
(12) Patent Application Publication
(10) Pub. No.: US 2018/0165374 A1
(43) Pub. Date: Jun. 14, 2018

(54) Faceconnect

(71) Applicant: YONATHAN MELAKU, Butner, NC (US)

(72) Inventor: YONATHAN MELAKU, Butner, NC (US)

(21) Appl. No.: 15/530,190

(22) Filed: Dec. 12, 2016

(51) Int. Cl. G06F 17/30; H04L 29/08; H04L 12/58

(52) U.S. Cl. CPC G06F 17/30876; H04L 67/02; G06F 17/30598; H04L 51/22; G06F 17/30867; H04L 67/306

(57) ABSTRACT

Facebook is currently the largest social media web site in the world with over 1.6 billion users and a market value of over 270 billion, but I believe that Faceconnect with its brand new features will beat Facebook.

### BACKGROUND OF THE INVENTION

Faceconnect is related to a social media website like Facebook. The field of endeavor to which it pertains is related to a website where people make a profile and share with friends.

### BRIEF SUMMARY OF THE INVENTION

This website will contain 11 new features which have not been used before as explained in the detailed description.

### DETAILED DESCRIPTION OF THE INVENTION

The website will have 11 new features which have never been used before on a social media website.

The first feature is the ability to add friends under different categories. Currently you can only add a friend simply as a friend and then choose the category to put them under. But with this feature you can directly add a friend into a category instead of as a friend. The category includes family, relatives, family friend, close friend, or distant friend and the ability to create a category.

The second feature is the ability to have different comment pages as walls for the different categories you directly added the profiles under.

The third feature is having an address book and phone book directly connected to the categories you added the profiles under. In other words, having a family address book and phone book, having relatives address book and phone book, and so on for all the five categories. The users can reflect who can view their address and phone numbers based on category (family, friend, distant friend, etc.) or based on selecting a profile individually (which to allow or not) by anyone.

The fourth feature is the map feature where you can see all your friends address on a map on a webpage. The webpage will be called personal friends map.

The fifth feature is the see who is looking for you feature where a person enters your name as the name they are looking for on their profile you can check who is looking for you simply by putting your name in a search box and hitting search.

The sixth feature is the website contact feature. In the same way as the fifth feature after putting the name you are looking for in your profile if that name ever signs up for a profile the website will let you know through an alert.

The seventh feature is that in the same manner as the sixth feature after putting in the name you are looking for in your profile, if that name ever signs up for a profile the company itself will get in contact with you instead of through the website alert.

The eight feature is the contact now button put on a profile that once you click on will give you the option to get in contact with the company so that they can directly contact the person on the profile on your behalf.

The ninth feature is the classmates feature which will be part of your profile if you choose to do so and can be searchable.

The tenth feature is the ability to council you to your school information and activities from the website and also tools for parents to monitor their kids school information like homework and etc.

The eleventh feature is the e-mail feature on the website where it works internally but also externally with other e-mail accounts outside of the website.

The claimed invention is:

1. Ability to directly add a profile into a category instead of first adding the profile as a friend and then after that in a category.

2. Different comment pages for the different categories.

3. Different address book and phone book for the different categories.

4. Map to view all the addresses of friends on a webpage.

5. Ability to add the name you are looking for on your profile so that that person can type their name in a see who is looking for you box and find out who is looking for them.

6. Ability to add the name you are looking for on your profile and the website alerting you when that name signs up on a profile on the website.

7. Ability to add the name you are looking for on your profile and the company contacting you if that person ever signs up for a profile.

8. A contact now button on the profiles so that when a person clicks on it, it will give them information for the company to contact the profile they want to contact.

9. E-mail that is used both internally with the website and externally outside of the website.
